(19) United States
(12) Patent Application Publication
(10) Pub. No.: US 2019/0318311 A1
(43) Pub. Date: Oct. 17, 2019

(54) SYSTEM AND METHODS FOR ACCURATE PRICE QUOTING AND GENERATION

(71) Applicant: Flexport, Inc., San Francisco, CA (US)

(72) Inventors: Michael Chen, San Francisco, CA (US); Arjun Rockwood Kavi, San Francisco, CA (US); Matthew Owen, San Francisco, CA (US); Brian Cameros, San Francisco, CA (US); Stephanie Yuan He, San Francisco, CA (US); Dounan Shi, San Francisco, CA (US)

(21) Appl. No.: 16/387,066

(22) Filed: Apr. 17, 2019

Related U.S. Application Data
(60) Provisional application No. 62/659,004, filed on Apr. 17, 2018.

(51) Int. Cl. G06Q 10/08; G06Q 30/02

(52) U.S. Cl. CPC G06Q 10/08355; G06Q 30/0283; G06Q 10/0838

(57) ABSTRACT

In an embodiment, the methods and systems disclosed herein utilize a cloud-based service to receive data relating to expected and estimated costs in a commercial transaction for freight. In an embodiment, a computer system generates an electronic commercial transport cost plan for all expected and estimated costs for executing a commercial shipping operation. In an embodiment, a computer system analyzes actual costs associated with a commercial shipping operation to update and modify costs in electronic commercial transport cost plans.

### BENEFIT CLAIM

This application claims the benefit under 35 U.S.C. § 119(e) of provisional application 62/659,004 filed Apr. 17, 2018, the entire contents of which is hereby incorporated by reference for all purposes as if fully set forth herein.

### TECHNICAL FIELD

One technical field of the present disclosure is freight shipping and management. Another technical field is freight shipping logistics and cost management. Another technical field is logistic data management and improvement.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Items in commerce are any items, objects, products, work-product, or tools that are transported from one location to another as part of a commercial transaction or contract. The modern freight shipping industry involves transporting copious amounts of items and products to and from various locations around the world and often across numerous borders. As a result, modern shipping processes must track and manage large amounts of logistical information including cost, time, and efficiency, as well as physical objects in order to efficiently and accurately transport those objects from one location to another.

Multiple costs and logistical scenarios occur during commercial transportation, in which items in commerce are shipped from one destination to another. Costs include expected costs, which are standard costs, often unavoidable, and associated with the commercial transaction through the shipping of items in commerce. Other cost examples include estimated costs, which are non-standard costs that may occur incidental to the commercial transaction, but which are not always expected to occur in the regular course of shipping items in commerce. As an example, a freight forwarder in charge of physical transportation of items may contract with an item supplier to commercially transport a set of items to a customer who will receive the items. The supplier may incur expected costs, such as the price of the contract, and the price of fuel to transport the items. However, estimated costs that may not be foreseen at the time of contracting between the parties, and include costs such as fuel for traffic stops, taxes, delays, or loss of items. These events are not guaranteed to occur as part of the commercial transportation, but affect the total cost of the commercial transaction.

Conventional methods of managing expected and estimated costs in the freight shipping and forwarding industry largely rely on receiving a cost bill after the commercial transaction has been completed and attempting to manually allocate incurred costs to responsible parties. The splitting of incurred costs to parties comes with numerous risks and is prone to human error. For example, a supplier may refuse to accept costs incurred by the freight forwarder that the supplier is at fault for, such as delays at a trucking weigh station caused by the supplier's misrepresentation of a cargo weight to the freight forwarder. In many cases estimated costs are largely ignored and left to be mediated between parties after a final cost bill has been incurred. Such deficiencies in the freight industry result in unfairly lopsided costs begin incurred by one party, and may force some entities to take on severe risks to fulfill a contract between parties. Some costs may be paid for in part due to lack of communication between parties and contractual terms made by humans are open to interpretation during mediations regarding the splitting of costs.

Attempts to account for estimated costs before the execution of a commercial shipping transaction to avoid these issues are also prone to confusion and human error. Including the full cost of a delay, which may or may not happen, in the contract price of a commercial transaction may confuse a party to the transaction about the actual cost incurred in agreeing to participate in commercial transportation. Further complicating cost allocation is that fact that estimated costs are prone to different probabilities of occurrence depending on a near infinite number of factors, and human guesswork is often involved in accounting for the probability of estimated costs. Worse still, incorrect human guesswork toward estimated cost probabilities is exacerbated by a lack of regular updating of the probabilities of estimated cost occurrences, which causes further deviation from an accurate and fair cost totaling for every party.

Therefore, there exists a need in the field of commercial shipping and transportation for a computer implemented method to automatically generate accurate, efficient, and fair electronic pricing cost plans for expected and estimated costs for parties to a commercial transaction. There further exists a need to allocate costs to transactional parties as part of the cost plans to ensure proper allocation of risk and costs. There exists a further need for a computer implemented method to freely and automatically update computer stored data used to generate pricing costs to better generate appropriate pricing plans. There further exists a need for electronic implementation of the above technologies for more efficient facilitation of cost plan estimation, sharing and implementation.

### BRIEF DESCRIPTION OF THE DRAWINGS

In the drawings:

FIG. 1 depicts a system that may be used to implement an embodiment.

FIG. 2 depicts an example process that may govern the operation of an embodiment.

FIG. 3 depicts an example general purpose computer system that may be used to implement aspects of an embodiment.

FIG. 4 depicts an example process that may govern the operation of an embodiment.

FIG. 5 depicts an example embodiment that may be used in implementing the example process.

FIG. 6 depicts an example embodiment that may be used in implementing the example process.

FIG. 7 depicts an example embodiment that may be used in implementing the example process.

FIG. 8 depicts an example embodiment that may be used in implementing the example process.

FIG. 9 depicts an example embodiment that may be used in implementing the example process.

FIG. 10 depicts an example embodiment that may be used in implementing the example process.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are depicted in block diagram form in order to avoid unnecessarily obscuring the present invention.

General Overview

In various embodiments of the techniques herein, a computer implemented method is used to collect data regarding a commercial transaction, the commercial transaction concerning the commercial shipping of one or more items in commerce. The collected data is used to generate an electronic commercial transport cost plan. An electronic commercial transport cost plan is any set of steps, instructions, or data representations relating to events occurring during the commercial shipping of the one or more items, and describes steps taken by entities involved in the commercial transaction along with monetary costs associated with those actions. Embodiments are described herein in the context of items in commerce (“freight”) for purposes of explanation, but embodiments are not limited to freight per se, and are applicable to any item of commerce.

Information is received by the computer system corresponding to details of a commercial transaction relating to the commercial shipping of freight. Received information includes information integral to the commercial shipping, such as a geographic origin, a geographic destination, a shipping entity that will carry the freight in a commercial vehicle, a description of the freight using measured values, etc. Also included in the received information may be any information that may relate to estimated occurrences during the execution of commercial shipping operations, including freight weight, driver/operator information, recommended dates of commercial shipping, etc.

Received information may be compared against information stored in a logistical data service that stores historical and current data relating to costs that have been or are expected to be incurred during freight shipping operations based on a variety of events. Based on the contents of the received information, a logistical data service returns, to the computer system, a variety of costs associated with executing events specified by the compared information. Costs are incurred as part of executing the commercial transport operation, where executing the commercial transport operation comprises transferring freight from one location to another location. The costs may be separated into two or more groups, at least two of the groups corresponding to expected costs, which are guaranteed to be incurred during the execution of a commercial transport operation, and estimated costs, which are costs that may or may not happen during the execution of a commercial transport operation based on occurrence probability.

The computer implemented system determines a total expected cost and a total estimated cost based on the cost information returned from the logistical data service. The total expected cost and the total estimated cost are used to generate an electronic commercial transport cost plan, which specifies an overall total cost of executing the commercial transaction agreed to by the contracting entities. Costs specified in the commercial transport cost plan may be grouped or itemized in such a way that two or more entities may delegate, through the computer system and to each other, various costs in the commercial transport cost plan. The electronic commercial transport cost plan may be in an electric format such that the plan can be readily shared between network connected devices for the convenience and efficiency of plan implementing users, and done at a rate faster than possible when sharing the plan manually between implementing users.

When the execution of commercial shipping has ceased, whether due to fulfillment of the commercial transaction or other circumstances, actual trip cost data associated with costs that were actually incurred during the execution of the commercial shipping operation may be received by the computer system. The computer system may use the actual trip cost data to modify and update values or parameters in the computer system and/or logistical data service in order to better reflect costs in future cost plan generation operations. The modification and/or updating of values or parameters in the computer system may include changing flat costs, estimated occurrence probabilities, adding or deleting costs or any other action necessary to automatically generate a more accurate and efficient electronic commercial transport cost plan in response to new or future commercial transactions involving the movement of freight commercially.

System Implementation

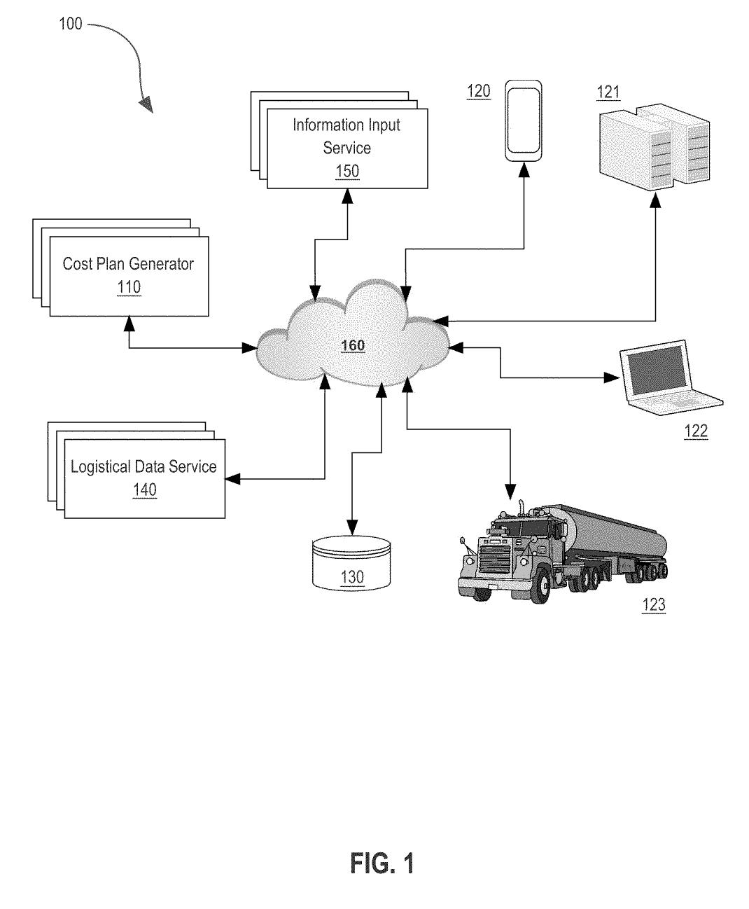

FIG. 1 depicts an example system 100 for the generation of commercial transport cost plans. Network 160 connects devices and systems 110-150. Network 160 may be any appropriate local area network, internet, intranet, cloud network, and/or other type of network or communication mechanism capable of facilitating communication between electronic entities, including those discussed herein. Network 160 may allow the facilitation of a cloud-based service that uses devices, systems, and services 110-150 to generate electronic commercial transport cost plans and share the cost plans among devices connected to cloud-network-based architecture.

Coupled to network 160 is cost plan generator 110. Cost plan generator 110 may be any device, system, or entity that is capable of generating a commercial transport cost plan. In various embodiments, cost plan generator 110 is a cloud-based computing service operating across one or more devices to generate electronic commercial transport cost plans as part of one or more commercial transactions. In various embodiments, cost plan generator 110 is a service integrated into a computer application, the computer application used to generate electronic commercial transport cost plans as part of the computer application functionality. In various further embodiments, the computer application is installed across various devices communicatively coupled together over network 160 and facilitates sharing, updating, modifying, and alerting other devices implementing the computer application to the use of electronic commercial transport cost plans.

Logistical data service 140 is connected to network 160. Logistical data service 140 may be any device, system, cloud-based program, or entity capable of storage, maintaining, modifying, or updating data related to costs and occurrences encountered during commercial shipping. In various embodiments, logistical data service 140 communicates directly with cost plan generator 110 over network 160 or any other sufficient connective entity to send and receive information that is used in the generation of an electronic commercial transport cost plan based on information stored electronically in logistical data service 140. In various embodiments, logistical data service 140 implements a database architecture to store in computer memory the information related to generation of an electronic commercial transport cost plan. In various embodiments, logistical data service 140 is a cloud-based storage system capable of communicating to various devices connected to a cloud-architecture information related to generation of an electronic commercial transport cost plan.

Information input service 150 is connected to network 160. Information input service 150 may be any device, system, or entity capable of accepting, inputting, receiving, or facilitating information related to costs or events related to a commercial transaction. In various embodiments, information input service 150 is present on a user device and receives information from a user regarding a commercial transaction or commercial shipping operation. In various further embodiments, measurement input service 150 sends received user input directly to logistical data service 140 and/or cost plan generator 110 to facilitate the generation of a commercial transport cost plan. In various embodiments, information input service 150 is a service integrated into a computer application, the computer application used to receive direct user data input, and display data to users, regarding commercial transactions. In various further embodiments, the computer application is installed across various devices communicatively coupled together over network 160 and facilitates sharing, updating, modifying, and alerting other devices implementing the computer application to data regarding commercial transactions that will be sent to other entities in system 100.

Devices 120-123 are connected to network 160. Devices 120-123 may be any device, system, or entity that may further aid in the measurement, storage, grouping, or generation of a build plan relating to package data. Device 120 may be a smartphone capable of using a computer application that may facilitate the generation of an electronic commercial transport cost plan. For example, device 120 may be employed by a contracting commercial entity utilizing information input service 150 in a computer application to specify parameters of a commercial transaction that will be sent to cost plan generator 110 over network 160.

Device 121 may be a series of servers or computing devices that store, for access, various data such as data that may be included as part of logistical data service 110. In an additional example, device 121 may be a series of servers that host cloud-based services such as cost plan generator 110 and facilitates communication of cloud-based information to various cloud connected devices, such as devices 120-123. Device 122 may be a personal computing device utilized to generate and/or view an electronic commercial transport cost plan. Commercial vehicle 123 may be a commercial vehicle including built-in technology or connectivity devices that can communicate over network 160 to send or receive relevant information to the generation of a commercial transport cost plan.

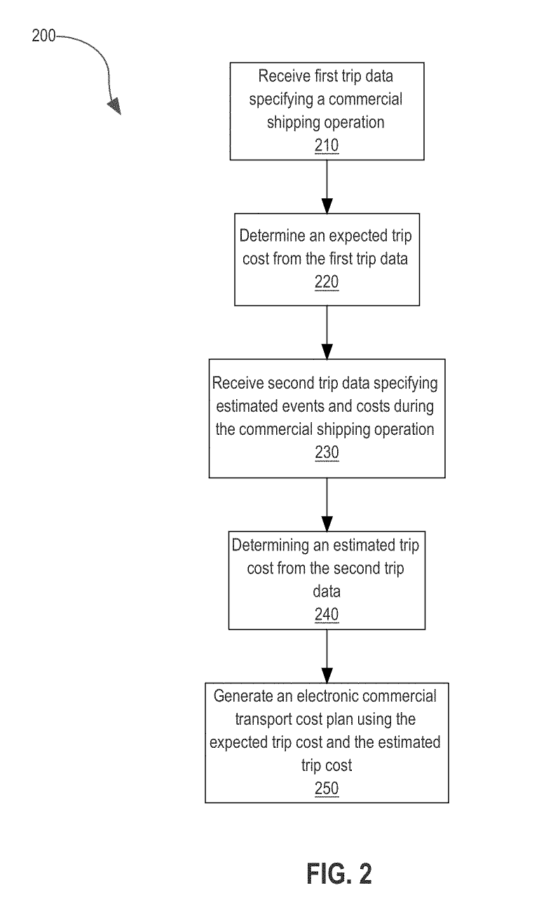

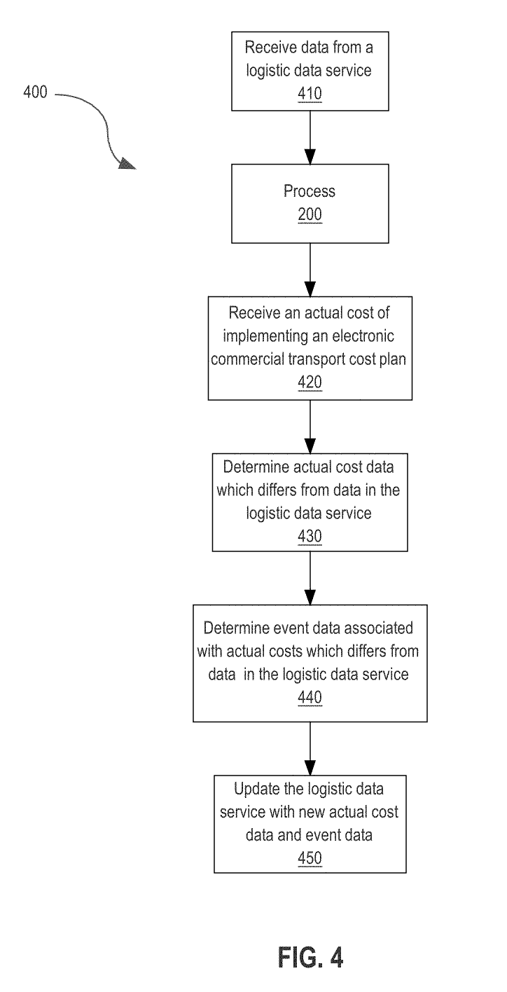

Storage 130 is connected to network 160. Storage 130 may be any storage device, software, application, or entity that is capable of storing digital information. In various embodiments, storage 130 may replace any other entity in example system 100 that allows the storage of digital information. For example, storage 130 may store in an electronic memory, one or more electronic commercial transport cost plans as part of processes described herein. In various embodiments, the example system 100 as described herein executes the steps of process 200 or process 400, depicted in FIG. 2 and FIG. 4 respectively.

Process Overview

FIG. 2 depicts an example process 200 that may govern operation of an embodiment. Process 200 begins with receiving 210 first trip data that specifies a commercial transaction or commercial shipping operation. Received first trip data is then used to determine 220 one or more expected trip costs. Second trip data is received 230 that specifies estimated events and costs that may occur according to a specified probability during the commercial shipping operation. Received second trip data is then used to determine 240 one or more estimated trip costs. The expected trip costs and estimated trip costs are then used to generate 250 an electronic commercial transport cost plan that describes a total cost of a commercial transaction or a shipping operation.

Returning to step 210, the computer system receives first trip data related to a commercial transaction or commercial shipping operation. First trip data may be any data that allows a determination of an expected trip cost, which is an assured cost that a party to a commercial transaction will incur as a result of executing a commercial shipping operation. In various embodiments, first trip data may be logistic information data relating to the parameters or specific details of a commercial transaction for shipping freight. For example, first trip data may be basic geographic and time data, such as a location of departure, a location of arrival, a date of departure, a date of arrival, a time of departure, a time of arrival, a contracted price, driver information, freight physical characteristics, etc.

In various embodiments, first trip data is received at step 210 by cost plan generator 110. In various further embodiments, first trip data is received by the cost plan generator 110 by accessing the first trip data in a computer memory, such as storage 130. In various further embodiments, first trip data is received directly from user input via information input service 150. In various further embodiments, first trip data is received from an electronic storage maintained by logistical data service 140.

At step 220, the computer system determines an expected trip cost based on the received 210 first trip data. An expected trip cost may be any representation of costs that are expected to be incurred during the execution of a commercial transaction involving freight shipping. In various embodiments, expected trip costs are trip costs that are expected to occur with a 100% probability during fulfillment of a commercial transaction. For example, a fulfilled commercial transaction may comprise a contract price paid to a freight forwarder, a salary for a commercial vehicle operator, fixed costs, such as meals and hotel payments during a commercial shipping operation, etc.

In various embodiments, a computer system such as cost plan generator 110 determines an expected trip cost in response to receiving 210 the first trip data specifying a commercial shipping operation. In various embodiments, previously determined expected trip costs are stored in an electronic memory and in response to receiving 210 the first trip data, cost plan generator 110 may receive from the electronic memory one to more previously determined expected trip costs determined from similar first trip data to the received first trip data. For example for received first trip data specifying only a location of departure and arrival, the cost plan generator 110 may search electronic memory for a previous expected trip cost having the same locations of departure and arrival. Cost plan generator 110 may then use the stored expected trip costs as a determination of an expected trip cost.

In various embodiments, determining 220 an expected trip cost comprises calculating an expected trip cost by summation of all costs specified by the received first trip data. For example, expected costs may be determined using the following formula:

Expected Cost=c₁+c₂+c₃+. . . +cₙ

Where c₁, c₂, c₃, . . . cₙ are the costs derived from the received first trip data. For example, an expected trip cost may be the summation of individual costs relating to known factors such as contract price, vehicle operator fees, fuel and transportation costs, driver/operator salaries, etc. In various further embodiments, cost plan generator 110 performs these calculations by using a separate service to calculate costs. In various embodiments the separate service is part of system 100. In various embodiments, the separate service is an outside service, such as a mapping service or logistical transportation API in a computer application. For example, first trip data specifying a first location as the location of departure and a second location as the location of arrival may be sent to a mapping service, wherein the separate mapping service determines the physical mile measurement that a commercial vehicle will need to travel by roadway between the first location and the second location, in order to determine an expected cost relating to transportation between the first and second locations.

In various embodiments, cost plan generator 110 automatically determines an expected cost upon receiving 210 the first trip data. In various embodiments, cost plan generator 110 automatically generates an expected cost upon receiving an indication from information input service 150 that all relevant first trip data has been sent to cost plan generator 110. In various embodiments, cost plan generator 110 determines an expected cost using received first trip data in response to receiving an indication from a user to determine the expected cost.

At step 230, the computer system receives second trip data related to estimated occurrences during a commercial transaction or commercial shipping operation. Second trip data may be any data that allows a determination of an estimated trip cost. In various embodiments, second trip data may be data relating to the parameters of a commercial transaction for shipping freight. For example, second trip data may be conditional data relating to probabilities of occurrences know to result in costs during the execution of a commercial transaction, such as weather delay costs, driver delay costs, traffic delay costs, customs and enforcement costs, etc.

In various embodiments, received second trip data may be of a form similar to first trip data and used to determine estimated costs. In various embodiments, receiving second trip data comprises extracting second trip data from the received first trip data. For example, if it is possible to encounter traffic between an input first location and an input second location, the price of delivering freight from the first location to the second location may comprise an expected cost due to the fixed distance between the locations, as discussed above. Furthermore, a probability of traffic delays occurring between the first location and the second location may result in estimated costs based only on knowing the two locations and probability that traffic will be encountered. Because such costs are variable and subject to probabilities that are not assured, those costs cannot be expected costs and therefore are determined as estimated costs for freight shipping.

In various embodiments, second trip data is received at step 230 by cost plan generator 110. In various further embodiments, second trip data is received by the cost plan generator 110 by accessing the second trip data in a computer memory, such as storage 130. In various further embodiments, second trip data is received directly from user input via information input service 150. In various further embodiments, second trip data is received from an electronic storage maintained by logistical data service 140.

At step 240, the computer system determines an estimated trip cost based on the received 230 first trip data. An estimated trip cost may be any representation of costs that have a probability of occurrence during the execution of a commercial transaction involving freight shipping. In various embodiments, estimated trip costs are trip costs that have an occurrence probability between 0% and 100% probability chance during fulfillment of a commercial transaction.

In various embodiments, a computer system such as cost plan generator 110 determines an estimated trip cost in response to receiving 230 the second trip data specifying a commercial shipping operation. In various embodiments, previously determined estimated trip costs are stored in an electronic memory and in response to receiving 230 the second trip data, cost plan generator 110 may search the electronic memory for one to more expected trip costs having similar first trip data to the received second trip data. For example for received second trip data specifying a location of departure and arrival, cost plan generator 110 may search electronic memory for a previous estimated trip cost concerning traffic delay costs having the same locations of departure and arrival, provided the probability of encountering traffic delay costs remains the same and the cost of such delays is the same. Cost plan generator 110 may then use the stored estimated trip costs as a determination of an estimated trip cost.

In various embodiments, determining 240 an estimated trip cost comprises calculating an estimated trip cost according to any number of formulae utilizing the cost of a potential occurrence and the probability of the occurrence occurring. In an embodiment, the estimated cost is a summation of all costs specified by the received second trip data multiplied by a corresponding probability of the cost occurring. For example, estimated costs may be determined using the following formula:

Estimated Cost=c₁*p₁+c₂*p₂+c₃*p₃+. . . +cₙ*pₙ

Where c₁, c₂, c₃, . . . cₙ are the costs derived from the received second trip data and p₁, p₂, p₃, . . . pₙ are the probabilities that the corresponding costs occur. For example, an estimated trip cost may be the summation of individual costs relating to possible factors such as traffic delays, driver delays, loss of freight, toll road usage, vehicular failure, etc. In various further embodiments, cost plan generator 110 performs these calculations by using a separate service to calculate costs. In various embodiments, the separate service is an outside service, such as a mapping service or logistical transportation API in a computer application. For example, second trip data specifying a first location as the location of departure and a second location as the location of arrival, may be sent to a traffic monitoring service that determines the current flow of vehicular traffic between the first location and the second location. The cost plan generator may also receive information from a current fuel pricing service to determine the price of fuel that may be expended during a traffic delay. Information from both services may be used to determine an estimated cost.

In various embodiments, cost plan generator 110 automatically determines an estimated cost upon receiving 230 the second trip data. In various embodiments, cost plan generator 110 automatically generates an estimated cost upon receiving an indication from information input service 150 that all relevant second trip data has been sent to cost plan generator 110. In various embodiments, cost plan generator 110 determines an estimated cost using received second trip data in response to receiving an indication from a user to determine the estimated cost.

In various embodiments, determining an estimated cost comprises using a function to calculate the estimated cost of an occurrence. For example, estimated costs may comprise a function corresponding to a mathematical curve, in which cost is a function of variable for time expended and probability of traffic. In various embodiments, determining an estimated cost comprises using a confidence interval to calculate an estimated cost. A confidence interval is a distributed range of values, such that there exists a probability—or “confidence”—that a particular value is included in the distribution of values. For example, certain costs having a probability of occurrence corresponding to a confidence of at least 95%, meaning there is a 95% probability that the cost is included in a standard distribution, will be included in the determined estimated cost.

At step 250, the computer system generates an electronic commercial transport cost plan using the calculated 220, 240 expected trip cost and estimated trip cost. As mentioned herein, an electronic commercial transport cost plan may be any electronic data that is capable of conveying, to a user or a system, the costs associated with executing a commercial transaction. In various embodiments, generating 250 an electronic commercial transport cost plan is done when either of steps 220 or 240 are complete. In various embodiments, generation of an electronic commercial transport cost plan in done in response to the completion of one or both of steps 220 and/or 240.

In various embodiments, cost plan generator 110 automatically generates an electronic commercial transport cost plan upon determining 220, 240 the expected cost and the estimated cost. In various embodiments, cost plan generator 110 automatically generates an electronic commercial transport cost plan upon receiving an indication from information input service 150 that all relevant first and second trip data has been sent to cost plan generator 110. In various embodiments, cost plan generator 110 generates an electronic commercial transport cost plan in response to receiving an indication from a user to generate the electronic commercial transport cost plan.

In various embodiments, in response to generating an electronic commercial transport cost plan, the electronic commercial transport cost plan is sent to one or more devices that convey the electronic commercial transport cost plan to one or more users. In various further embodiments, the electronic commercial transport cost plan is first sent to an operating user for acceptance by the operating user. In response to acceptance by the operating user, the electronic commercial transport cost plan is dispatched to one or more commercial entities participating in a commercial transaction. For example for a freight forwarding company and a supplier who have entered into a commercial transaction, a generated electronic commercial transport cost plan may be sent to both parties for viewing of the electronic commercial transport cost plan. Either party way review the electronic commercial transport cost plan at a receiving device to determine the parameters and costs involved in the commercial transaction as specified in the electronic commercial transport cost plan.

In various embodiments, the electronic commercial transport cost plan is a simple list comprising the sum of the expected cost and the estimated cost. In various embodiments, the electronic commercial transport cost plan is an itemized list of costs comprising the expected trip cost and the estimated trip cost. In various embodiments, the electronic commercial transport cost plan comprises a total cost that is a combination of the expected trip costs and the estimated trip costs in addition to the itemized costs. In various embodiments, the electronic commercial transport cost plan specified that parties to a commercial transaction are responsible for paying costs relating to commercial shipping as specified in an electronic commercial transport cost plan.

FIG. 4 depicts an example process 400 that may govern operation of an embodiment. Process 400 builds on process 200 by using computer implemented methods to update and modify received data to generate more accurate and efficient electronic commercial transport cost plans for future use. Process 400 begins by receiving data from a logistical data service. Process 200 is then executed using the data from the logistical data service. Once an electronic commercial transport cost plan has been generated 250, actual cost data of implementing the cost plan is received 420. The actual cost data is compared with the received 410 data from the logistical data service to determine 430 cost differences. The actual cost data is further compared to events in the logistical data service to determine 440 events associated with the actual costs that differ from data in the logistical data service 140. The determined data is then used to update 450 data in the logistical data service to better reflect accurate cost and events.

Returning to step 410, cost plan generator 110 receives data from the logistical data service 140. Logistical data service 140 can store electronic data for sending to cost plan generator 110 and electronic data can be taken from any electronic source and may comprise any electronic data that is relevant to generating an electronic commercial transport cost plan. In various embodiments, logistical data service 140 is a historical database storing past information relating to costs incurred. For example, logistical data service 140 may receive, from information input service 150, data which will be used to generate an electronic commercial transport cost plan and store such data for future use, including sending the data to cost plan generator 110. In various embodiments, step 410 is similar to step 210, wherein the received first trip data is stored in the logistical data service 140 and sent to the cost plan generator 110. In various embodiments, step 410 is similar to step 230, wherein the received second trip data is stored in the logistical data service 140 and sent to the cost plan generator 110.

After data is received from logistical data service 140, process 200 is executed to generate an electronic commercial transport cost plan as described above. As a result of process 200, an electronic commercial transport cost plan exists based on the data received 410 from the logistical data service, the electronic commercial transport cost plan comprising an expected cost and an estimated cost for occurrences during a commercial shipping operation.

At step 420, an actual cost is received that represents to the real cost of implementing the electronic commercial transport cost plan. In various embodiments, the real cost is a monetary value or one or more costs that one or more entities incurred as a result of executing a commercial shipping operation according to the generated electronic commercial transport cost plan. In various embodiments, the actual cost is an itemized cost list having various costs that were incurred during the execution of the commercial shipping operation and sorted by expected costs and estimated costs.

In various embodiments, the actual cost includes one or more costs that were not included in the generated electronic commercial transport cost plan. In various embodiments, the actual cost does not include one or more costs that were not included in the generated electronic commercial transport cost plan. In various embodiments, the actual cost is received from a user utilizing a cloud-based application on a user device such as device 120, as described in more detail hereinafter. In various further embodiments, the actual cost in input using information input service 150. In various further embodiments, an electronic bill of sale is sent to system 100 and the actual cost is determined from the electronic bill of sale. In various embodiments, a physical invoice is scanned and transformed into data that is input into system 100 as part of step 420.

At step 430, actual cost data that differs from data in the logistical data service 140 is determined. Actual cost data that differs from data in the logistical data service 140 is any data that does not match parameters of data stored in electronic memory in the logistical data service 140. For example, actual cost data may specify a price of fuel for a commercial vehicle that is not the price of fuel as stored electronically in the logistical data service 140. In various embodiments, actual cost data corresponding to a cost that is not included in logistical data service 140 differs from data in the logistical data service 140. In various embodiments, data included in the generated electronic commercial transport cost plan that is not in the actual cost data differs from the data in the logistical data service 140.

At step 440, event data associated with actual costs that differs from data in the logistical data service 140 is determined. Event data that differs from data in the logistical data service 140 is any data that does not match parameters of data stored in electronic memory in the logistical data service 140. For example, event data may specify that a traffic delay did not occur during execution of a commercial transaction corresponding to the generated electronic commercial transport cost plan. As a result, there was a 0% probability of traffic during the execution, which differs from a non-zero probability of a traffic delay as stored in the logistical data service 140. As a further example, event data may specify that a toll road was used during execution of the commercial transaction corresponding to the electronic commercial transport cost plan. As a result, there was a 100% probability of toll road usage during the execution, which differs from a non-assured probability of toll road usage as stored in the logistical data service 140.

At step 450, the logistical data service 140 is updated to include new cost and event data. Updating the logistical data service 140 may comprise manipulation of and/or change in the data stored on the logistical data service 140. In various embodiments, only data that differs according to steps 430 and 440 above will be updated in logistical data service 140. In various embodiments, differing data is updated to include new costs and probabilities according to the differences noted. For example, the fuel price in the logistical database may be updated to comply with the actual cost data for fuel at the present time. As a further example, the probabilities of encountering a traffic delay and a toll road may be decreased and increased respectively based on the event data.

In various embodiments not pictured in FIG. 4, an update of an electronic commercial transport cost plan is performed based on the updated/modified data in the logistical data service. In various further embodiments, an electronic commercial transport cost plan corresponding to a commercial shipping operation that has not yet been executed is updated. In various further embodiments, an electronic commercial transport cost plan corresponding to a commercial shipping operation that has concluded is updated.

In various further embodiments, an electronic commercial transport cost plan corresponding to a commercial shipping operation that is currently being executed is updated. The expected and estimated costs in such an electronic commercial transport cost plan are updated in real-time to include accurate current costs based on received dynamic trip data. For example, if the price of diesel fuel changes during the execution of a commercial shipping operation, the corresponding electronic commercial transport cost plan may be updated to account for the received dynamic trip data specifying the difference in price of diesel fuel.

In various embodiments, a difference cost is calculated as the summation of differences in costs determined during the execution of a commercial shipping operation and the updating of the electronic commercial transport cost plan. In various further embodiments, the difference cost is added to the electronic commercial transport cost plan. In various further embodiments, the difference cost is delegated to one or more parties to the commercial transaction. In various embodiments, a notification is sent to one or more parties to a commercial transaction notifying the parties that an update has occurred in the electronic commercial transport cost plan.

In various embodiments not depicted in FIGS. 2 and 4, a commercial transportation vehicle may be any vehicle capable of transporting freight from one location to another, including, but not limited to, a truck, a delivery van, an airplane, a freight ship, a train, a drone or autonomous aerial vehicle, a bicycle, a motorcycle, an electric scooter, etc. In various embodiments not pictured in FIGS. 2 and 4, cost plan generator 110 may further generate an electronic commercial transport cost plan including a recommendation for the most efficient and cost-effective actions to be taken to fulfill a commercial transaction. For example, cost plan generator 110 may determine that an estimated cost of using a toll highway is less than the estimated cost of using a public highway and incurring a potential traffic event. In such a case, the cost plan generator may generate an electronic commercial transport cost plan specifying the use of a toll highway instead of a public highway to lower estimated costs.

In various embodiments not pictured in FIG. 2 or 4, an expected or estimated cost may be represented as a nested cost, wherein one cost is incidental to the performance of another cost. For example, the cost of a vehicle operators daily meals may be incidental to the cost of a driver delay. As such, an extra day of driver meals are incurred as costs when an extra day is necessary to complete a commercial shipping operation, causing a driver delay cost. In various embodiments, nested costs are represented visually using indicators in the electronic commercial transport cost plan.

Example Embodiments

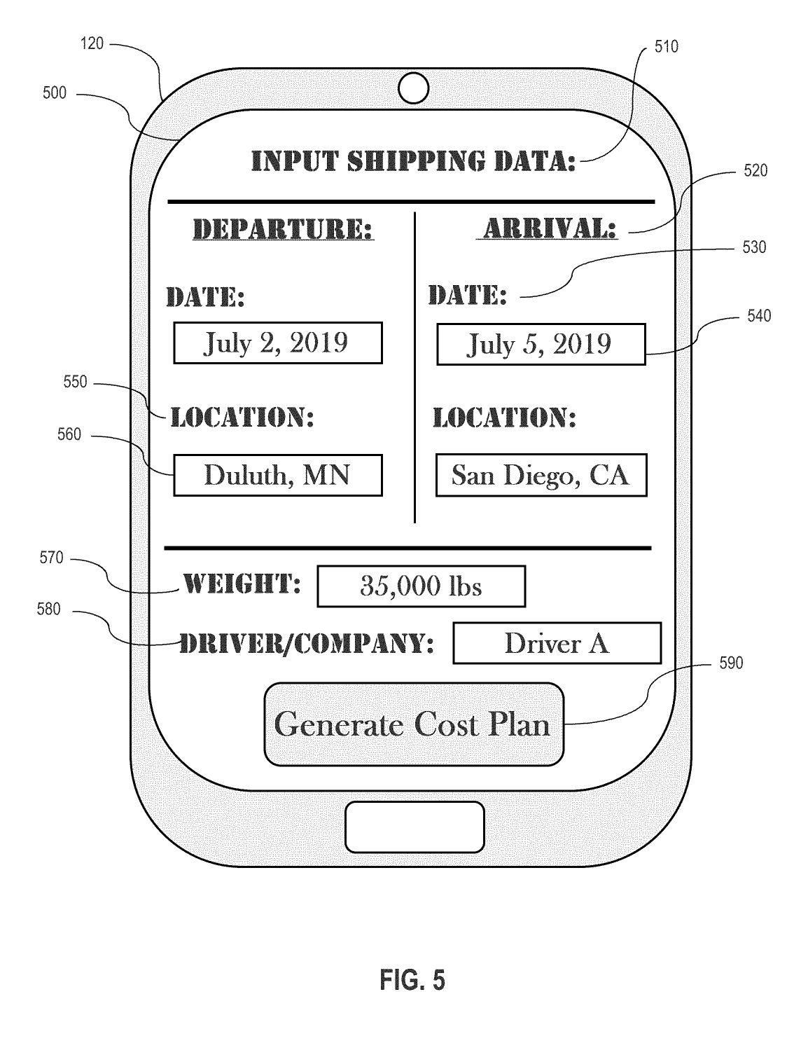

FIG. 5 depicts an example embodiment that may be used in implementing the example processes. Specifically, FIG. 5. depicts device 120 being utilized as a user mobile device for the input of shipping data that may be used as first or second trip data. The input of shipping data on device 120 may be similar to process steps 210 or 230. Device 120 has a screen 500 that implements a graphical user interface as part of a mobile application running on device 120. The graphical user interface may comprise any information necessary to allow operation of the mobile application.

As depicted in FIG. 5, an input prompt 510 may be displayed on the screen 500 of device 120 that shipping data is to be input. The input prompt 510 may be any visual representation necessary to prompt a user to enter shipping data details for a commercial transaction. For example, FIG. 5 depicts an input prompt of “INPUT SHIPPING DATA.” A departure/arrival prompt 520 may be displayed indicating that a section of the interface is dedicated to shipping data input corresponding to a time when a departure of freight or an arrival of freight is to take place. Departure/arrival prompt 520 prompts a user to input data specifying the departure or arrival of freight as part of a commercial transaction. For example, FIG. 5 depicts departure/arrival prompts 520 specifying an area for data input corresponding to “DEPARTURE” related data and a separate area for data input corresponding to “ARRIVAL” related data.

Within a section of the interface under departure/arrival prompt 520, a date prompt 530 prompts a user to input a calendar date for which the freight in a commercial transaction is to depart or arrive. The information may be entered by a user in date field 540 using any method of input available. For example, as depicted in FIG. 5, a user has been prompted for a “DATE” under the departure and arrival sections and has input “JULY 2, 2019” in the departure date field, and “JULY 5, 2019” in the arrival data field. In various embodiments a user types a date into date field 540. In various embodiments, a user selects a data from a menu or calendar of available dates. In various embodiments, a date data is automatically added by the computer system by importing the data from a previous commercial transaction or by proactively guessing a date based on previous data input. Though date prompt 530 and date field 540 are prompts and input fields corresponding to a date, any information may be prompted for and entered that will aid in the generation of an electronic commercial transport cost plan.

A location prompt 550 may be displayed indicating that a user is to input a geographic location for which the freight in a commercial transaction is to depart or arrive depending on the corresponding departure/arrival prompt 520. The information may be entered by a user in location field 560. For example, as depicted in FIG. 5, a user has been prompted for a “LOCATION” under the departure and arrival sections and has input “Duluth, Minn.” in the departure location field, and “San Diego, Calif.” in the arrival data field. In various embodiments a user types a location into location field 560. In various embodiments, a user selects a location from a menu or map of available locations. In various embodiments, location data is automatically added by the computer system by importing the data from a previous commercial transaction or by proactively guessing a location based on previous data input.

A weight prompt and field 570 may be displayed to prompt a user to input a freight weight for which the freight in a commercial transaction will weigh. For example, as depicted in FIG. 5, a user has been prompted for a “WEIGHT” and has input “35,000 pounds” in the field. The weight information may be entered by a user into the field in any manner, including the manners discussed above.

An entity prompt and field 580 may be displayed to prompt a user to input a transportation entity by which the freight in a commercial transaction will be transported. For example, as depicted in FIG. 5, a user has been prompted for a “DRIVER/COMPANY” that is responsible for transportation of freight as part of a commercial transaction, which the user has responded to by inputting “DRIVER A” into the field. The entity information may be entered by a user into the field in any manner, including the manners discussed above. In various embodiments, a user may input more than one driver/company into the field to specify multiple entities that are involved in a commercial transaction.

In various embodiments a user may user a dedicated input button 590 to finalize and send to system 100 the package data input at device 120. For example, FIG. 5 shows a “GENERATE COST PLAN” button that a user will press on display 500 to indicate to device 120 that all necessary information needed to generate an electronic commercial transport cost plan has been input to device 120. In various embodiments, information input service 150 will not send data from the user's input to other entities of system 100 until a user has pressed dedicated input button 590.

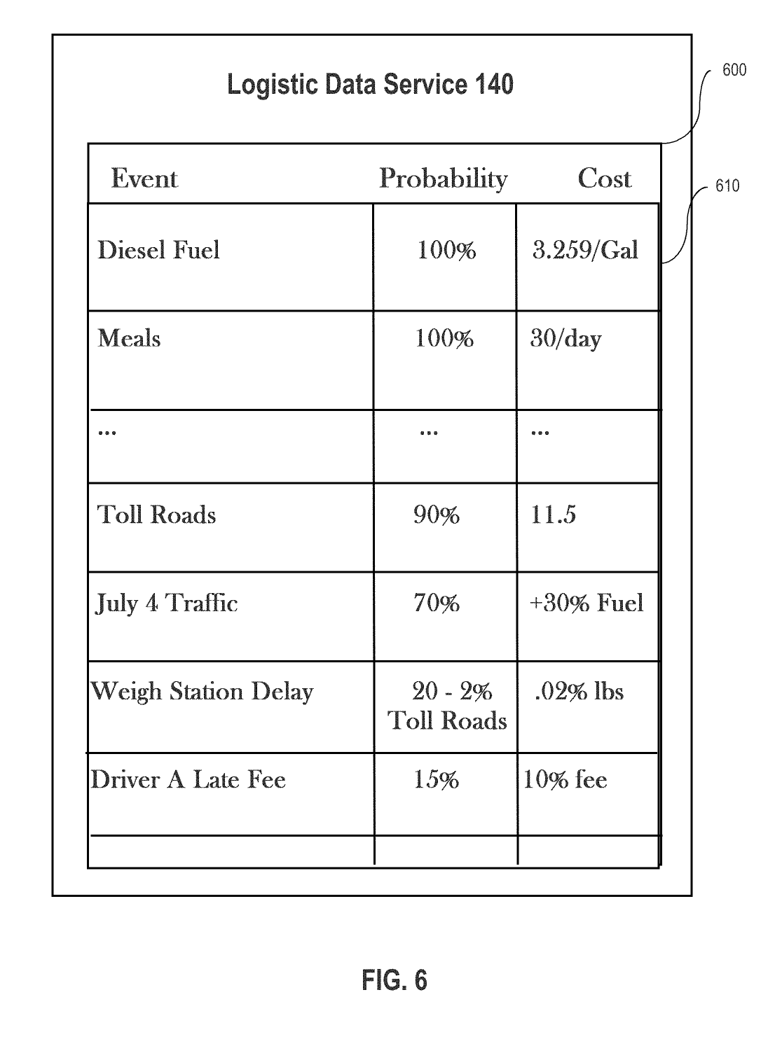

As depicted in FIG. 6, logistical data service 140 may store a table 600 of data related to various costs that may be part of a commercial transaction. A selection 610 of data in the logistical data service 140 and table 600 may correspond to an event that has a probability of occurring and a cost for the occurrence of that event.

Various examples of possible selections 610 showing events having corresponding probabilities and costs are depicted in table 600. For example, as depicted in FIG. 6, an example of an event is the cost of diesel fuel that will be used by a commercial vehicle such as input device 123 to physically transport freight. Diesel fuel has a cost of $3.259 per gallon and has a 100% probability of being incurred as a cost in a commercial transaction. Therefore, the cost of diesel fuel will be received 210 as first trip data that will determine 220 and expected cost. Meal costs are similarly 100% guaranteed and cost $30 per day, which will be factored into expected costs.

Table 600 also contains a toll road event as a selection. A toll road event in logistical data service 140 may correspond to general toll costs in a general commercial transaction or a specific toll cost corresponding to a driving route between two cities, such as Duluth, Minn. and San Diego, Calif. The toll road event selection has a corresponding cost of $11.50 and a 90% probability of occurring during a route. Costs may be presented as proportional to other costs in table 600. For example, as depicted in FIG. 5, a July 4 traffic delay event selection in table 600 has a probability of occurrence of 70% but a cost of an additional 30% of diesel fuel expenditures. Therefore, the cost of the July 4 traffic delay event will be calculated after the calculated expected cost for diesel fuel.

Similarly, event probabilities may be dependent on probabilities of other events selections in table 600. For example, encountering a weigh station may be less likely if a vehicle driver proceeds on a route which includes toll roads. As depicted in FIG. 6, a Weigh Station Delay event may have a probability of occurrence of 20%, minus a 2% chance if a toll road is taken. Therefore, the inclusion of a toll road cost in delivery route may correspond to less chance of encountering a weigh station delay. A corresponding cost for a weigh station delay may be a cost proportional to 0.02% of weight in pounds expressed as dollars. Event probabilities and costs may further depend on information relating to parties to a commercial transaction. For example, FIG. 5 depicts a Driver Late Fee event in table 600 stipulating that there exists a 15% probability that Driver A is late in delivering a commercial shipment. This probability of incurring a late fee may be based on the historical rate at which Driver A has been late to deliver freight in past commercial transactions. A corresponding cost may be expressed as a percentage of the overall fee being paid to the freight forwarder for whom Driver A works.

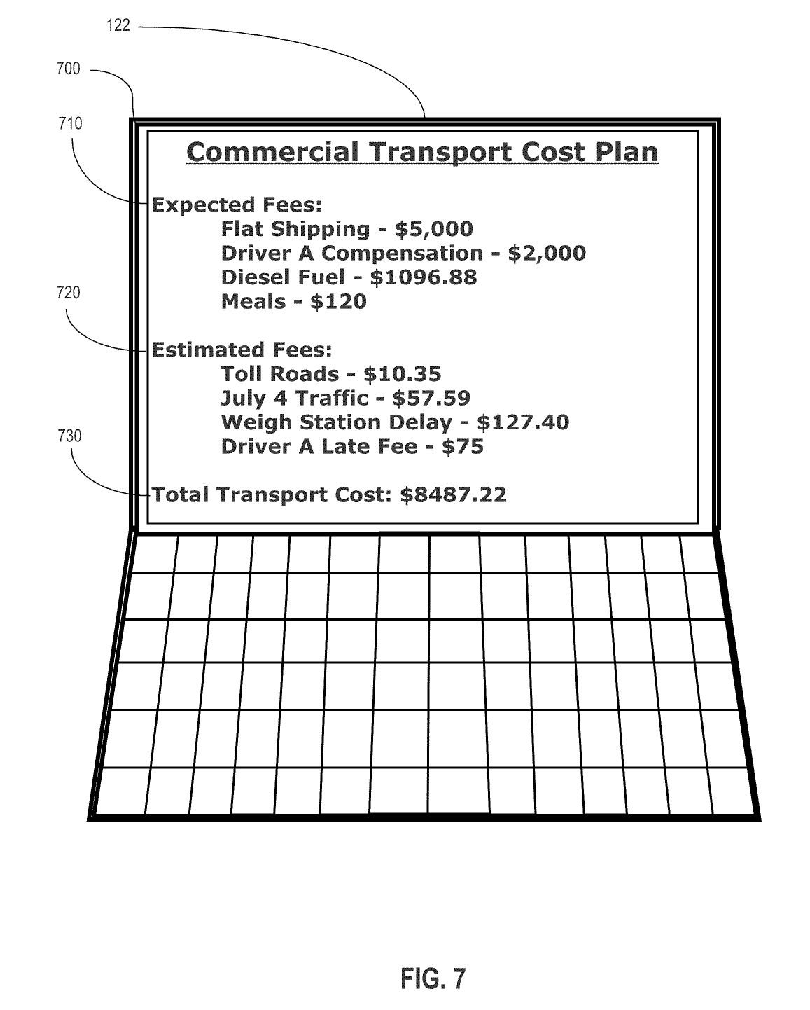

As depicted in, FIG. 7 a visual representation of an electronic commercial transport cost plan may be displayed on the screen 700 of device 122. The cost plan may include the expected cost 710. In various embodiments, the expected cost is displayed as an itemized list of all costs that are expected in the execution of the commercial transaction. The cost plan may include the estimated cost 720. In various embodiments, the estimated cost is displayed as an itemized list of all costs that are estimated to occur in the execution of the commercial transaction. As discussed above, the estimated cost may be derived using any formula for probabilities in events occurring.

For example, as depicted in FIG. 7, the costs are calculated and displayed using the above formula for cost calculation based on multiplying event costs by event probabilities. For example, each expected cost is calculated by multiplying the fee indicated in table 600 by one, corresponding to a 100% chance of occurring. The flat shipping fee for a freight forwarder may be a fixed fee, such as $5,000. The compensation for the specified Driver A may be a fixed $2,000 and meals for Driver A are fixed at $30 per day. The meal cost is multiplied by four days, as indicated by the input of departure and arrival dates of Jul. 2, 2019 and Jul. 5, 2019 respectively in FIG. 5, making the total $120. Diesel Fuel is calculated by multiplying the cost of diesel fuel as specified in table 600 of $3.259 per gallon by the number of miles between Duluth, Minn. and San Diego, Calif. and dividing the result by the average miles per gallon of a commercial transportation vehicle, resulting in an expected cost for fuel of $1,096.88.

As a further example, the estimated fees are calculated in a similar manner with the corresponding probabilities being used instead of the number one. A toll road flat fee is multiplied by a 90% probability to estimated $10.35 in cost for using tolls. Traffic delay events multiple the expected probability of encountering traffic of 70% by 30% of the expected fee of fuel cost as specified above to obtain an estimated cost of $57.59. A weigh station delay event is calculated by multiplying the probability of encountering a weigh station delay as calculated above by the expected cost, resulting in an estimated cost of $127.40. A Driver A late fee having a probability of 15% is multiplied by 10% of the contract fee specified in the expected costs, resulting in an estimated late fee of $75. The cost plan may include a compiled total of the expected cost 710 and the estimated cost 720 as a total cost 730, which is the sum of the expected cost 710 and the estimated cost 720, namely $8487.22.

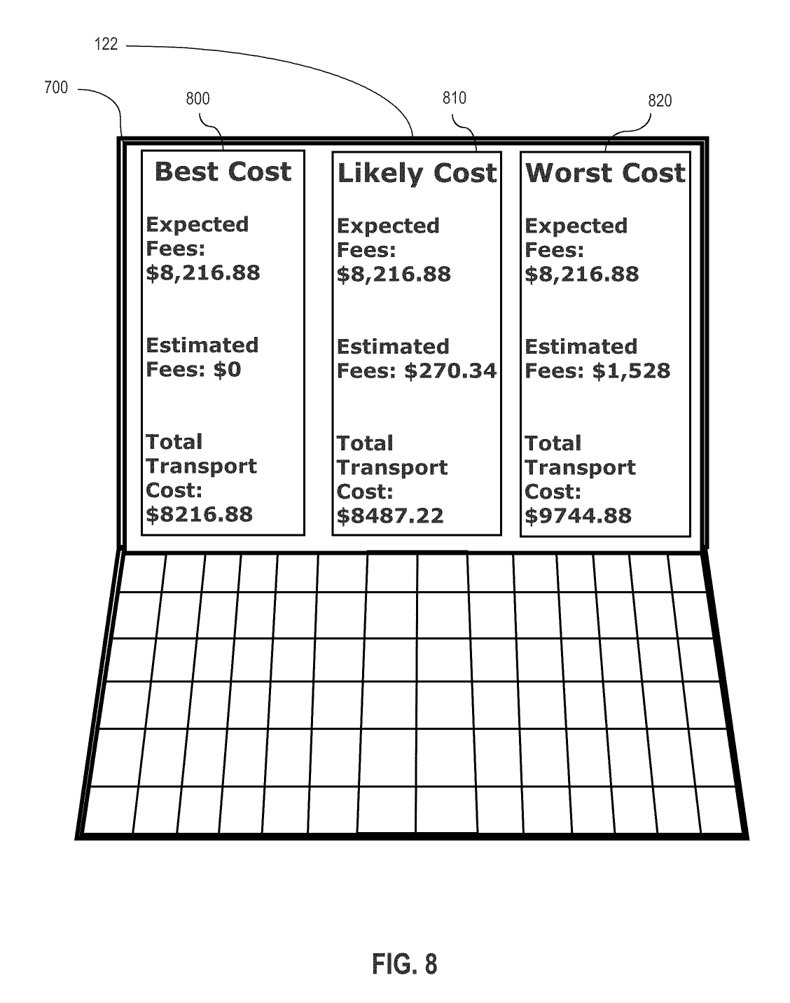

As depicted in, FIG. 8 a visual representation of multiple generated electronic commercial transport cost plans may be displayed on the screen 700 of device 122. A first cost plan may be a likely cost plan 810. The likely cost plan may be generated by applying probabilities of estimated events to the cost of such events to calculate an estimated cost, as described above. Another cost plan may a best cost plan 800, which is the scenario in which the least amount of estimated costs possible are incurred. A best cost plan 800 may be generated by substituting a probability of zero for all estimated costs during determination 240 of the estimated cost. As a result, estimated fees are non-existent in the total transport cost. Another cost plan may be a worst cost plan 820. A worst cost plan 820 may be generated by substituting a probability of 100% for all estimated costs during determination 240 of the estimated cost. As a result, estimated fees are at the highest possible rate and correspond to the highest total transport cost.

In various embodiments, any number of plans can be generated based on specified criteria for review by an entity on device 122. Each of the generated plans may be an alternative electronic commercial transport cost plan which describes an alternative structured cost of executing a commercial shipping operation. For example, a freight forwarding company may wish to see each of best cost plan 800, likely cost plan 810 and worst cost plan 820 concurrently on a computer screen 700 to determine the forwarder's likely risk in entering into a commercial transaction. In various embodiments, various plans are generated that use different probabilities or costs according to different criteria to generate plans having costs between the best cost plan and the worst cost plan. In various embodiments, a plan may be selected by user input on device 122 specifying that a user will undertake the risk of entering into a commercial transaction based on the selected cost.

In various embodiments, the selection and acceptance by a commercial entity of a particular electronic commercial transport cost plan is based on a confidence interval. In various embodiments, an entity will automatically agree to a commercial transaction having an electronic commercial transport cost plan which is within a degree of confidence threshold value. For example, a likely electronic commercial transport cost plan may have a total cost value that has an occurrence probability that is 95% confident. A party to a commercial transaction may automatically accept any plan which comports with at least a 68% confidence threshold value, resulting in the automatic selection of the likely cost plan.

As a further example, the best cost electronic commercial transport cost plan may have a total cost value that has an occurrence probability that is 32% confident, resulting in automatic dismissal of the best cost plan because it does not rise to the level of 68% confidence. In various embodiments, a user or entity will automatically reject any electronic commercial transport cost plan that does not fall within a specified confidence interval. In various embodiments, a user or entity will automatically accept any electronic commercial transport cost plan that falls within a specified confidence interval or standard deviation.

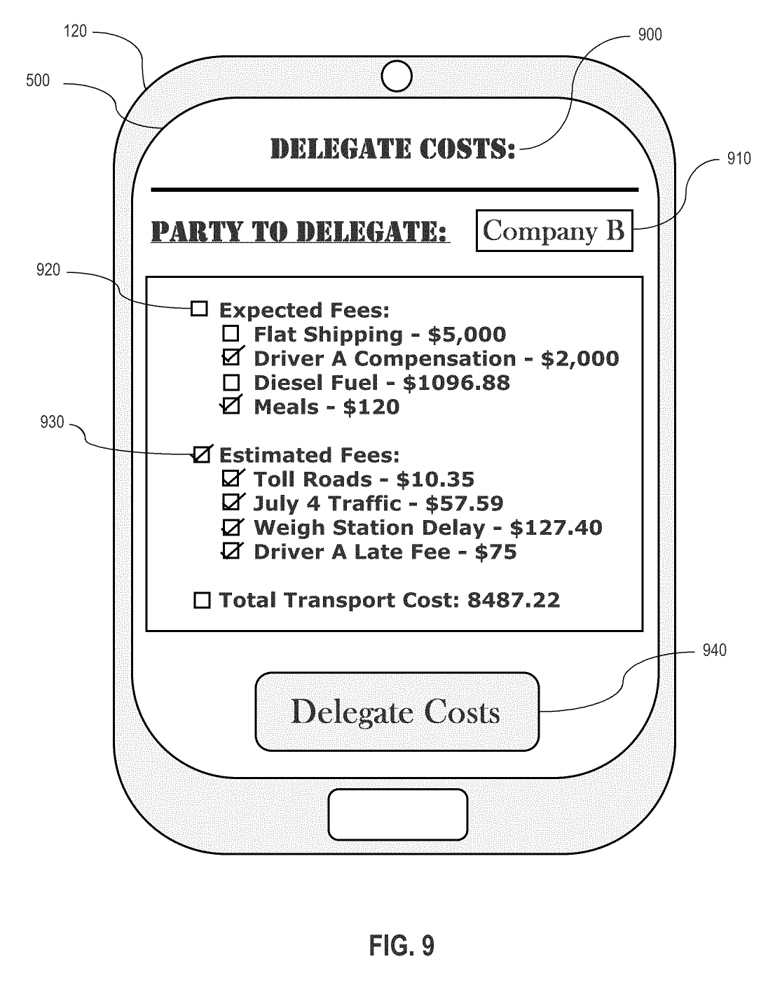

As depicted in FIG. 9, a delegation of costs prompt 900 may be displayed on the screen 500 of device 120 indicating that the expected and estimated costs in the generated electronic cost plan may be delegated to one or more entities. A party delegation prompt and field 910 may be displayed prompting a user to input data regarding the entity with that costs will be delegated. Expected delegations 920 may be presented by that a user may select from various individual costs to delegate to the party specified in delegation prompt and field 910. Estimated delegations 930 may be presented by which a user may select from various individual costs to delegate to the party specified in delegation prompt and field 910.

In various embodiments, a user may select all, none or a subset of costs, or sub-costs, on screen 500 to delegate to the party. Sub-costs may be expected sub-costs or estimated sub-costs. In various embodiments, visual selection icons appear next to itemized costs to indicate that a specified itemized cost has been selected for delegation. In various further embodiments, selection of a selection icon next to the expected delegations 920, estimated delegations 930, or total transport costs cause the delegation of the entire amount of cost to a party.

For example, as depicted in FIG. 9, Company B has been selected as the party to whom selected costs will be delegated. In an embodiment, Company B is a freight forwarder who has contracted to carry freight on behalf of a user. The user has selected Driver A compensation and Meals under expected costs, showing that the user expects Company B to pay for these costs as part of the commercial transaction. The user has also selected all of the estimated delegations 930, showing that the user expects Company B to pay for any of these delays during the commercial shipping. User has not delegated flat shipping fees and cost of fuel, which the user believes are costs that the user will pay for.

In various embodiments a user may use a dedicated delegation button 940 to finalize and send to system 100 the delegation of costs data input at device 120. For example, FIG. 9 shows a “DELEGATE COSTS” button that a user will press on display 500 to indicate to device 120 that all necessary information needed to delegate costs to the party specified in delegation prompt and field 910 has been entered and/or selected on display 500. In various embodiments, cost will not be delegated until a user has pressed the dedicated delegation button 940 after selection costs for delegation. In various embodiments, in response to pressing dedicated delegation button 940, the cost delegations are shared with any number of parties involved in the commercial transaction, including Company B.

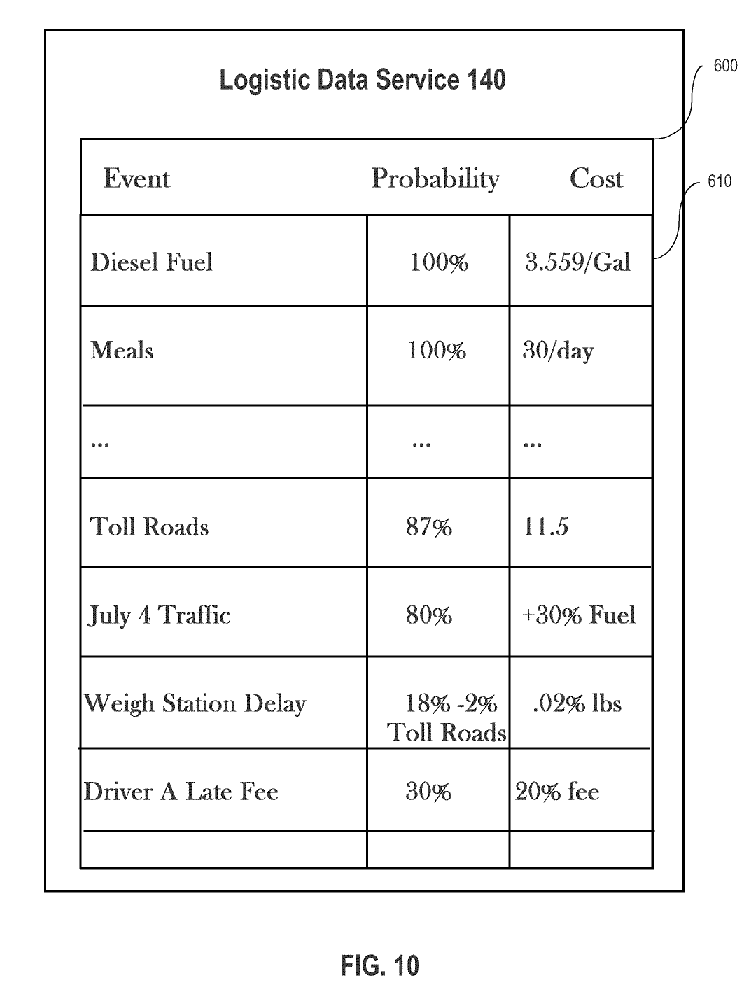

As depicted in FIG. 10, logistical data service 140 may store a table 600 of data related to various costs that may be part of a commercial transaction that has been updated in response to receiving actual costs associated with an electronic commercial transport cost plan. A selection 610 of data in the logistical data service 140 and table 600 may be modified, updated, added, or deleted corresponding to data from the actual costs received. For example, an actual cost plan may specify that the price of diesel fuel has increased, modifying the diesel fuel selection to comprise a cost of $3.559 per gallon. The meals selection remains unchanged.

The toll road event probability has been lowered, likely in response to determining that the actual cost did not include a cost related to a toll road. The July 4 traffic delay event probability has been raised, likely in response to determining that a traffic delay cost was incurred as part of the actual cost. The weigh station delay event probability has been lowered, likely in response to determining that the actual cost did not include a weigh station delay. In various embodiments, the actual cost may change both the cost and the probability. For example, the Driver A late fee event probability has been raised, likely in response to determining that a late fee cost was incurred in the actual cost. As a result, the corresponding cost for a Driver A late fee event has been raised as well to increase punitive measures on the Company B for future late shipments.

Implementation Mechanisms

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

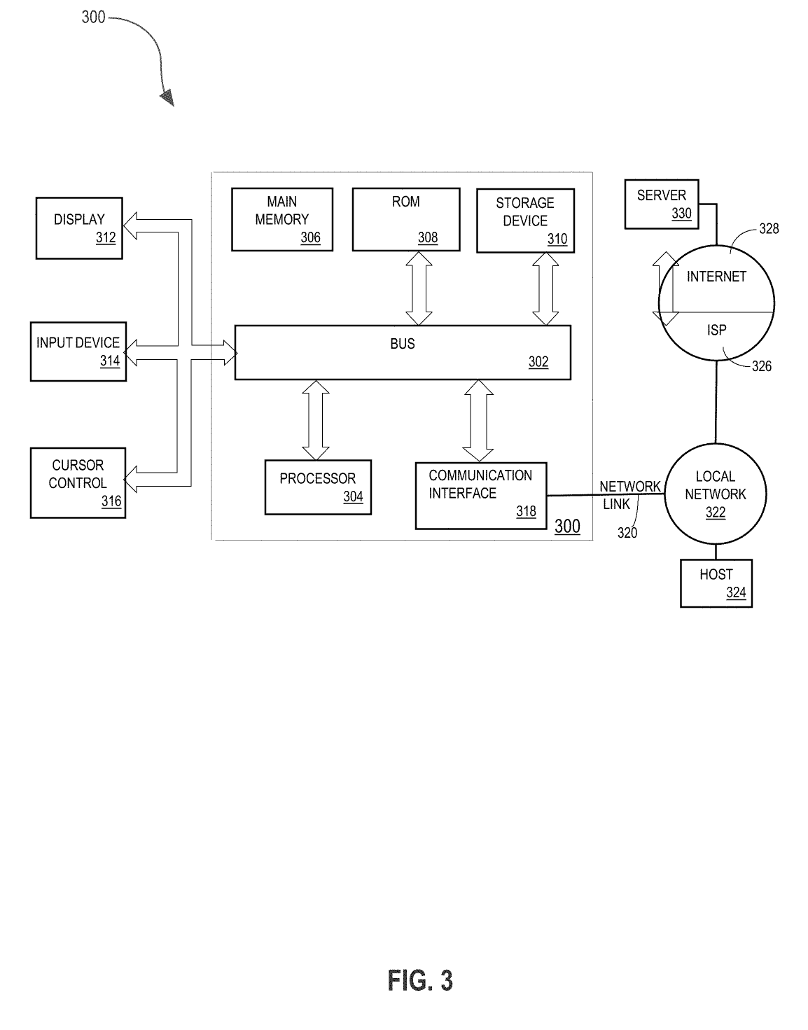

FIG. 3 is a block diagram that depicts an example computer system with which an embodiment may be implemented. In the example of FIG. 3, a computer system 300 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 300 includes an input/output (I/O) subsystem 302 which may include a bus and/or other communication mechanism(s) for communicating information and/or instructions between the components of the computer system 300 over electronic signal paths. The I/O subsystem 302 may include an I/O controller, a memory controller and at least one I/O port. The electronic signal paths are represented schematically in the drawings, for example as lines, unidirectional arrows, or bidirectional arrows.

At least one hardware processor 304 is coupled to I/O subsystem 302 for processing information and instructions. Hardware processor 304 may include, for example, a general-purpose microprocessor or microcontroller and/or a special-purpose microprocessor such as an embedded system or a graphics processing unit (GPU) or a digital signal processor or ARM processor. Processor 304 may comprise an integrated arithmetic logic unit (ALU) or may be coupled to a separate ALU.

Computer system 300 includes one or more units of memory 306, such as a main memory, which is coupled to I/O subsystem 302 for electronically digitally storing data and instructions to be executed by processor 304. Memory 306 may include volatile memory such as various forms of random-access memory (RAM) or other dynamic storage device. Memory 306 also may be used for storing temporary variables or other intermediate information during execution of instructions to be executed by processor 304. Such instructions, when stored in non-transitory computer-readable storage media accessible to processor 304, can render computer system 300 into a special-purpose machine that is customized to perform the operations specified in the instructions.

Computer system 300 further includes non-volatile memory such as read only memory (ROM) 308 or other static storage device coupled to I/O subsystem 302 for storing information and instructions for processor 304. The ROM 308 may include various forms of programmable ROM (PROM) such as erasable PROM (EPROM) or electrically erasable PROM (EEPROM). A unit of persistent storage 310 may include various forms of non-volatile RAM (NVRAM), such as FLASH memory, or solid-state storage, magnetic disk or optical disk such as CD-ROM or DVD-ROM and may be coupled to I/O subsystem 302 for storing information and instructions. Storage 310 is an example of a non-transitory computer-readable medium that may be used to store instructions and data which when executed by the processor 304 cause performing computer-implemented methods to execute the techniques herein.

The instructions in memory 306, ROM 308 or storage 310 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 300 may be coupled via I/O subsystem 302 to at least one output device 312. In one embodiment, output device 312 is a digital computer display. Examples of a display that may be used in various embodiments include a touch screen display or a light-emitting diode (LED) display or a liquid crystal display (LCD) or an e-paper display. Computer system 300 may include other type(s) of output devices 312, alternatively or in addition to a display device. Examples of other output devices 312 include printers, ticket printers, plotters, projectors, sound cards or video cards, speakers, buzzers or piezoelectric devices or other audible devices, lamps or LED or LCD indicators, haptic devices, actuators or servos.

At least one input device 314 is coupled to I/O subsystem 302 for communicating signals, data, command selections or gestures to processor 304. Examples of input devices 314 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 316, which may perform cursor control or other automated control functions such as navigation in a graphical interface on a display screen, alternatively or in addition to input functions. Control device 316 may be a touchpad, a mouse, a trackball, or cursor direction keys for communicating direction information and command selections to processor 304 and for controlling cursor movement on display 312. The input device may have at least two degrees of freedom in two axes, a first axis, for example, x, and a second axis, for example, y, that allows the device to specify positions in a plane. Another type of input device is a wired, wireless, or optical control device such as a joystick, wand, console, steering wheel, pedal, gearshift mechanism or other type of control device. An input device 314 may include a combination of multiple different input devices, such as a video camera and a depth sensor.

In another embodiment, computer system 300 may comprise an internet of things (IoT) device in which one or more of the output device 312, input device 314, and control device 316 are omitted. Or, in such an embodiment, the input device 314 may comprise one or more cameras, motion detectors, thermometers, microphones, seismic detectors, other sensors or detectors, measurement devices or encoders and the output device 312 may comprise a special-purpose display such as a single-line LED or LCD display, one or more indicators, a display panel, a meter, a valve, a solenoid, an actuator or a servo.

When computer system 300 is a mobile computing device, input device 314 may comprise a global positioning system (GPS) receiver coupled to a GPS module that is capable of triangulating to a plurality of GPS satellites, determining and generating geo-location or position data such as latitude-longitude values for a geophysical location of the computer system 300. Output device 312 may include hardware, software, firmware and interfaces for generating position reporting packets, notifications, pulse or heartbeat signals, or other recurring data transmissions that specify a position of the computer system 300, alone or in combination with other application-specific data, directed toward host 324 or server 330.

Computer system 300 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 300 in response to processor 304 executing at least one sequence of at least one instruction contained in main memory 306. Such instructions may be read into main memory 306 from another storage medium, such as storage 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 310. Volatile media includes dynamic memory, such as memory 306. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 302. Transmission media can also take the form of acoustic or light waves, such as those generated during radio-wave and infra-red data communications.

Various forms of media may be involved in carrying at least one sequence of at least one instruction to processor 304 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 300 can receive the data on the communication link and convert the data to a format that can be read by computer system 300. For instance, a receiver such as a radio frequency antenna or an infrared detector can receive the data carried in a wireless or optical signal and appropriate circuitry can provide the data to I/O subsystem 302 such as place the data on a bus. I/O subsystem 302 carries the data to memory 306, from which processor 304 retrieves and executes the instructions. The instructions received by memory 306 may optionally be stored on storage 310 either before or after execution by processor 304.

Computer system 300 also includes a communication interface 318 coupled to bus 302. Communication interface 318 provides a two-way data communication coupling to network link(s) 320 that are directly or indirectly connected to at least one communication networks, such as a network 322 or a public or private cloud on the Internet. For example, communication interface 318 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 322 broadly represents a local area network (LAN), wide-area network (WAN), campus network, internetwork or any combination thereof. Communication interface 318 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 318 sends and receives electrical, electromagnetic or optical signals over signal paths that carry digital data streams representing various types of information.

Network link 320 typically provides electrical, electromagnetic, or optical data communication directly or through at least one network to other data devices, using, for example, satellite, cellular, Wi-Fi, or BLUETOOTH technology. For example, network link 320 may provide a connection through a network 322 to a host computer 324.

Furthermore, network link 320 may provide a connection through network 322 or to other computing devices via internetworking devices and/or computers that are operated by an Internet Service Provider (ISP) 326. ISP 326 provides data communication services through a world-wide packet data communication network represented as internet 328. A server computer 330 may be coupled to internet 328. Server 330 broadly represents any computer, data center, virtual machine or virtual computing instance with or without a hypervisor, or computer executing a containerized program system such as DOCKER or KUBERNETES. Server 330 may represent an electronic digital service that is implemented using more than one computer or instance and that is accessed and used by transmitting web services requests, uniform resource locator (URL) strings with parameters in HTTP payloads, API calls, app services calls, or other service calls. Computer system 300 and server 330 may form elements of a distributed computing system that includes other computers, a processing cluster, server farm or other organization of computers that cooperate to perform tasks or execute applications or services. Server 330 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 330 may comprise a web application server that hosts a presentation layer, application layer and data storage layer such as a relational database system using structured query language (SQL) or no SQL, an object store, a graph database, a flat file system or other data storage.

Computer system 300 can send messages and receive data and instructions, including program code, through the network(s), network link 320 and communication interface 318. In the Internet example, a server 330 might transmit a requested code for an application program through Internet 328, ISP 326, local network 322 and communication interface 318. The received code may be executed by processor 304 as it is received, and/or stored in storage 310, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening several instances of the same program often means more than one process is being executed. Multitasking may be implemented to allow multiple processes to share processor 304. While each processor 304 or core of the processor executes a single task at a time, computer system 300 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

What is claimed is:

1. A computer-implemented method comprising:
receiving, at a computer system, first trip data specifying logistic information relating to items which will be transported commercially;
determining, by the computer system, an expected trip cost, wherein the expected trip cost is determined based on the first trip data;
receiving, at a computer system, second trip data specifying estimated logistic occurrences while the items are transported commercially, wherein each estimated logistic occurrence is associated with one or more occurrence probabilities;
determining, by the computer system, an estimated trip cost, wherein the estimated trip cost is determined based on the second trip data and the one or more occurrence probabilities; and
generating, by the computer system, an electronic commercial transport cost plan, wherein the electronic commercial transport cost plan is based on both the expected trip cost and the estimated trip cost.

2. The computer-implemented method of claim 1, further comprising:
sending, by the computer system, to a historical database, the first trip data;
receiving, from the historical database, based on the first trip data, one or more expected sub-costs;
sending, by the computer system, to the historical database, the second trip data;
receiving, from the historical database, based on the second trip data sent, one or more estimated sub-costs associated with one or more occurrence probabilities.

3. The computer-implemented method of claim 2, further comprising:
receiving, an actual trip cost, wherein the actual trip cost is a cost of implementing the electronic commercial transport cost plan;
sending, by the computer system, to the historical database, the actual trip cost;
updating, at the historical database, the first trip data, the second trip data and the one or more occurrence probabilities based on the actual trip cost.

4. The computer-implemented method of claim 1, further comprising:
determining, by the computer system, one or more alternative estimated trip costs, wherein each alternative estimated trip costs, of the one or more alternative estimated trip costs, is determined based on different occurrence probabilities associated with each estimated logistic occurrence.
generating, by the computer system, one or more alternative electronic commercial transport cost plans, wherein each alternative electronic commercial transport cost plans, of the one or more alternative electronic commercial transport cost plans, is generated based on both the expected trip cost and one or the one or more alternative estimated trip costs.

5. The computer-implemented method of claim 1, wherein the one or more occurrence probabilities are percentages value of likelihood based on a probability of an estimated logical occurrence occurring, and wherein determining, by the computer system, an estimated trip cost is based on a cost of one or more estimated logical occurrences and an associated percentage value of likelihood of the estimated logical occurrence.

6. The computer-implemented method of claim 1, wherein the one or more occurrence probabilities are confidence interval values of likelihood based on a probability of an estimated logistic occurrence occurring, and wherein determining, by the computer system, an estimated trip cost is based on excluding, from the estimated trip cost, any costs associated with estimated logistic occurrences having a confidence interval value below a threshold value.

7. The computer-implemented method of claim 1 wherein:
the electronic commercial transport cost plan comprises itemized costs for commercial transportation, and
the computer-implemented method further comprises:
associating, by the computer system, at least a portion of the itemized costs with a first commercial entity;
associating, by the computer system, at least a portion of the itemized costs with a second commercial entity.

8. The computer-implemented method of claim 7, wherein:
the itemized costs include the expected trip cost;
each itemized cost is associated with one or more occurrence probabilities;
associating, by the computer system, at least a portion of the itemized costs with the first commercial entity comprises associating itemized costs associated with occurrence probabilities below a specified threshold value with the first commercial entity;
associating, by the computer system, at least a portion of the itemized costs with the second commercial entity comprises associating itemized costs associated with occurrence probabilities above a specified threshold value with the second commercial entity.

9. The computer-implemented method of claim 1, further comprising:
receiving, at the computer system, dynamic trip data, the dynamic trip data specifying occurrences not included in the electronic commercial transport cost plan;
generating, by the computer system, an updated electronic commercial transport cost plan based on the dynamic trip data;
sending, by the computer system via one or more computer networks to one or more commercial entities, the updated electronic commercial transport cost plan.

10. The computer-implemented method of claim 1, further comprising:
sending, by the computer system via one or more computer networks, the electronic commercial transport cost plan to a commercial entity;
receiving, by the computer system, an indication of acceptance of the electronic commercial transport cost plan;
in response to receiving the indication of acceptance, sending, by the computer system to one or more commercial entities via the one or more networks, the electronic commercial transport cost plan.

11. One or more non-transient computer-readable storage media comprising instructions which, when executed by a processor, cause the processor to:
receive, at a computer system, first trip data specifying logistic information relating to items which will be transported commercially;
determine, by the computer system, an expected trip cost, wherein the expected trip cost is determined based on the first trip data;
receive, at a computer system, second trip data specifying estimated logistic occurrences while the items are transported commercially, wherein each estimated logistic occurrence is associated with one or more occurrence probabilities;
determine, by the computer system, an estimated trip cost, wherein the estimated trip cost is determined based on the second trip data and the one or more occurrence probabilities; and
generate, by the computer system, an electronic commercial transport cost plan, wherein the electronic commercial transport cost plan is based on both the expected trip cost and the estimated trip cost.

12. The non-transient computer-readable storage media of claim 11, further comprising instructions which, when executed by the processor cause the processor to:
send, by the computer system, to a historical database, the first trip data;
receive, from the historical database, based on the first trip data, one or more expected sub-costs;
send, by the computer system, to the historical database, the second trip data;
receive, from the historical database, based on the second trip data sent, one or more estimated sub-costs associated with one or more occurrence probabilities.

13. The non-transient computer-readable storage media of claim 12, further comprising instructions which, when executed by the processor cause the processor to:
receive, an actual trip cost, wherein the actual trip cost is a cost of implementing the electronic commercial transport cost plan;
send, by the computer system, to the historical database, the actual trip cost;
update, at the historical database, the first trip data, the second trip data and the one or more occurrence probabilities based on the actual trip cost.

14. The non-transient computer-readable storage media of claim 11, further comprising instructions which, when executed by the processor cause the processor to:
determine, by the computer system, one or more alternative estimated trip costs, wherein each alternative estimated trip costs, of the one or more alternative estimated trip costs, is determined based on different occurrence probabilities associated with each estimated logistic occurrence.
generate, by the computer system, one or more alternative electronic commercial transport cost plans, wherein each alternative electronic commercial transport cost plans, of the one or more alternative electronic commercial transport cost plans, is generated based on both the expected trip cost and one or the one or more alternative estimated trip costs.

15. The non-transient computer-readable storage media of claim 11, wherein the one or more occurrence probabilities are percentages value of likelihood based on a probability of an estimated logical occurrence occurring, and wherein determining, by the computer system, an estimated trip cost is based on a cost of one or more estimated logical occurrences and an associated percentage value of likelihood of the estimated logical occurrence.

16. The non-transient computer-readable storage media of claim 11, wherein the one or more occurrence probabilities are confidence interval values of likelihood based on a probability of an estimated logistic occurrence occurring, and wherein determining, by the computer system, an estimated trip cost is based on excluding, from the estimated trip cost, any costs associated with estimated logistic occurrences having a confidence interval value below a threshold value.

17. The non-transient computer-readable storage media of claim 11, wherein:
the electronic commercial transport cost plan comprises itemized costs for commercial transportation, and
further comprising instructions which, when executed by the processor cause the processor to:
associate, by the computer system, at least a portion of the itemized costs with a first commercial entity;
associate, by the computer system, at least a portion of the itemized costs with a second commercial entity.

18. The non-transient computer-readable storage media of claim 17, wherein:
the itemized costs include the expected trip cost;
each itemized cost is associated with one or more occurrence probabilities;
associating, by the computer system, at least a portion of the itemized costs with the first commercial entity comprises associating itemized costs associated with occurrence probabilities below a specified threshold value with the first commercial entity;
associating, by the computer system, at least a portion of the itemized costs with the second commercial entity comprises associating itemized costs associated with occurrence probabilities above a specified threshold value with the second commercial entity.

19. The non-transient computer-readable storage media of claim 11, further comprising instructions which, when executed by the processor cause the processor to:
receive, at the computer system, dynamic trip data, the dynamic trip data specifying occurrences not included in the electronic commercial transport cost plan;
generate, by the computer system, an updated electronic commercial transport cost plan based on the dynamic trip data;
send, by the computer system via one or more computer networks to one or more commercial entities, the updated electronic commercial transport cost plan.

20. The non-transient computer-readable storage media of claim 11, further comprising instructions which, when executed by the processor cause the processor to:
send, by the computer system via one or more computer networks, the electronic commercial transport cost plan to a commercial entity;
receive, by the computer system, an indication of acceptance of the electronic commercial transport cost plan;
in response to receiving the indication of acceptance, sending, by the computer system to one or more commercial entities via the one or more networks, the electronic commercial transport cost plan.
